(19) United States
(12) Patent Application Publication
(10) Pub. No.: US 2011/0030826 A1
(43) Pub. Date: Feb. 10, 2011

(54) MAGNETIC ASSEMBLY, A FLUID-FLOW ASSEMBLY AND AN INDICATOR

(76) Inventors: Christian Robert Haffenden Bahl, Taastrup (DK); Anders Smith, Birkerod (DK); Nini Pryds, Dragor (DK)

Correspondence Address: PILLSBURY WINTHROP SHAW PITTMAN, LLP, P.O. BOX 10500, MCLEAN, VA, 22102, US

(21) Appl. No.: 12/673,653

(22) PCT Filed: Jul. 15, 2008
(86) PCT No.: PCT/EP08/59224

§ 371 Date: Mar. 24, 2010

Related U.S. Application Data
(60) Provisional application No. 60/956,631, filed on Aug. 17, 2007.

(51) Int. Cl. F15C 1/04

(52) U.S. Cl. 137/803

(57) ABSTRACT

The invention provides a magnetic assembly, the assembly comprising: a magnet (4); and a ferromagnetic component (6) having at least two regions of different Curie temperature, the magnet (4) and the ferromagnetic component being movable with respect to each other in dependence on the temperature of the ferromagnetic component (6).

The present invention relates to a magnetic assembly, a fluid-flow assembly and an indicator.

Magnetic assemblies in the form of valves are known. An example of such a valve is disclosed in US-A-2006/0042260. In this document, there is disclosed a valve comprising a permanent magnet and a valve member made of a ferromagnetic material. The valve is for controlling the flow of fluid to a component of a gas turbine engine. Since the valve includes a component made of a ferromagnetic material in thermal contact with the fluid, it is responsive to the temperature of the ferromagnetic material, such that as the temperature of the fluid flowing to the gas turbine varies, so does the attraction between the permanent magnet and the ferromagnetic component. Thus, the assembly is essentially a temperature dependent valve.

Improvements in such assemblies are desired.

According to a first aspect of the present invention, there is provided a magnetic assembly, the assembly comprising: a magnet; and a component having at least two regions of different magnetic ordering temperature, the magnet and the component being movable with respect to each other in dependence on the temperature of the component.

Preferably, the component is ferromagnetic, the magnetic ordering temperature being the Curie temperature.

The invention provides a magnetic assembly that can be entirely passive. In other words the attraction and therefore the movement between the magnet and the ferromagnetic component can be dependent only on the temperature of the ferromagnetic component. Therefore in one embodiment the assembly can be used as an automatic switch which triggers when the temperature of the environment (and therefore the ferromagnetic component) reaches a certain threshold thus causing the magnet and the ferromagnetic component to move relative to each other.

In one embodiment, the assembly is a magnetic valve, wherein the magnet and the ferromagnetic component are movable with respect to each other to open and close the valve, at least one of the magnet and the ferromagnetic component being configurable such that the region of the ferromagnetic component that can engage with the magnet can be changed.

In an embodiment, the invention provides a magnetic valve including a ferromagnetic component having two regions of different Curie temperature. The ferromagnetic component is configurable such that the region of the ferromagnetic component that can engage with the magnet, can be varied. Accordingly, the temperature at which the valve is activated or deactivated may be changed. Thus, a single valve assembly may be used in applications in which the temperature of the flowing fluid is varied and in which it is desired to vary the activation temperature of the assembly.

The valve may be entirely passive such that no operator interaction is required to switch the valve. Indeed, the valve can operate entirely independently of operator intervention, solely dependent on the varying temperature of its environment e.g. the flowing fluid or the wider environment in which the valve is located.

According to a second aspect of the present invention, there is provided an assembly, comprising a conduit for a flowing fluid; and, a valve according to the first aspect of the present invention, the valve being arranged to provide temperature dependent control of the flow of the fluid through the conduit.

According to a third aspect of the present invention, there is provided an indicator comprising a magnet; and a ferromagnetic material component having at least two regions of different Curie temperature, the magnet and the ferromagnetic component being movable with respect to each other to indicate the state of the system.

Examples of embodiments of the present invention will now be described in detail with reference to the accompanying drawings, in which:

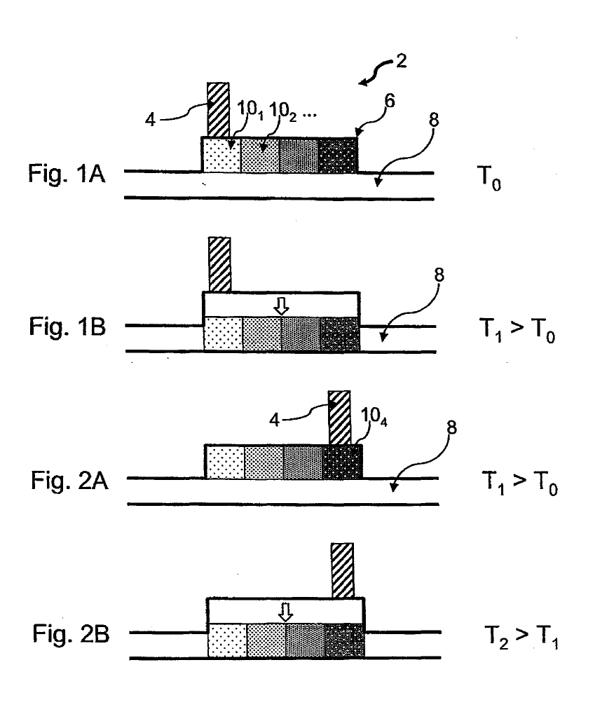

FIGS. 1A and 1B show a schematic representation of a magnetic valve in a first configuration both open and closed;

FIGS. 2A and 2B show the valve of FIGS. 1A and 1B in open and closed arrangements in a different configuration;

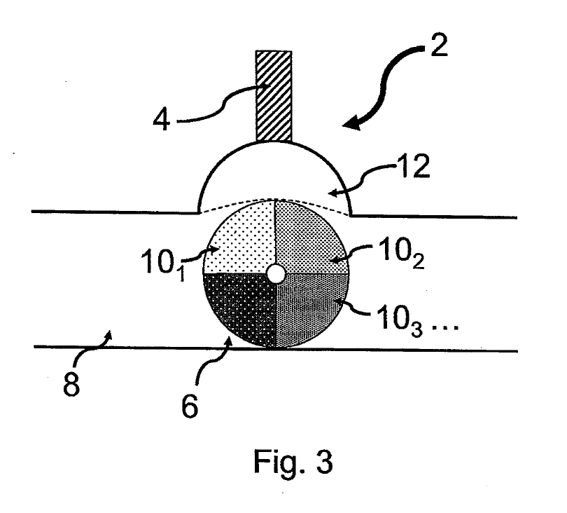

FIG. 3 shows a schematic representation of a magnetic valve;

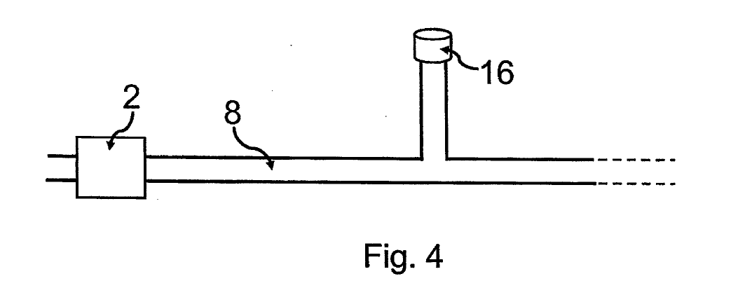

FIG. 4 shows a schematic representation of an irrigation system including a magnetic valve; and

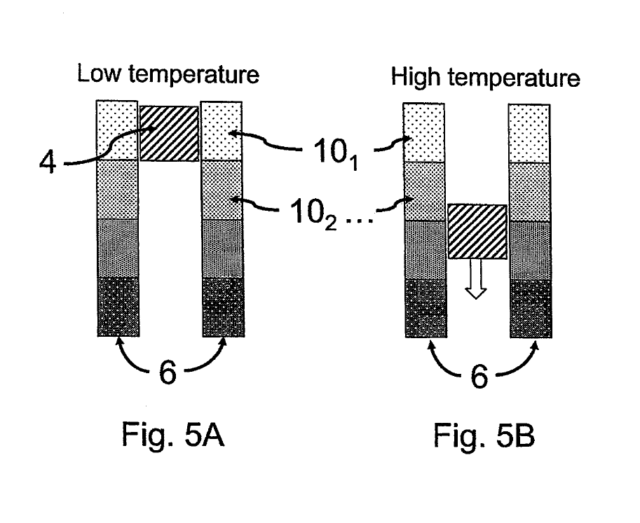

FIGS. 5A and 5B show a schematic representation of an example of a magnetic assembly.

FIG. 1A shows a schematic representation of a section through a magnetic assembly, which in this case is a valve 2. The valve 2 comprises a first part 4 comprising a magnet, such as a permanent magnet, and a second part 6 which is arranged to vary the size of an opening of the valve. A conduit 8 is shown for carrying a fluid. In this particular example, the second part 6 of the valve is a component made up of plural regions 10₁ to 10₄ each of which is selected to have a composition such as to have a magnetic ordering temperature at a desired value. Where the second part of the valve is ferromagnetic, the magnetic ordering temperature is the Curie temperature. It is preferred that the Curie temperature of each of the regions 10₁ to 10₄ is different and determined by the particular application.

FIG. 1B shows the valve 2 of FIG. 1A in a closed configuration wherein the second part 6 of the valve is blocking the flow of fluid within the conduit 8. Thus the second part 6 of the valve is movable between a first configuration (as shown in FIG. 1A) in which the valve is open such that fluid can flow freely along the conduit 8, and a second configuration (as shown in FIG. 1B) in which the valve is closed such that the second part 6 essentially blocks the flow of fluid within the conduit 8.

The fluid flowing in the conduit 8 in FIG. 1A is at a temperature T₀. The fluid flowing within the conduit 8 shown in FIG. 1B is at a temperature T₁, in which T₁ is greater than T₀ and greater than the Curie temperature T_{c1} of the region 10₁ of the second part 6. The second part 6 is made of a ferromagnetic material such that as the temperature of the second part 6 varies, so does the attractive force between the permanent magnet 4 and the second part 6. Thus, the attractive force varies with temperature of the fluid flowing within the conduit 8.

The magnetic valve can be seen to consist, in this example, of a magnet and a graded active component made, preferably, of ceramic materials with a Curie temperature varying in the temperature interval of interest. The active component 6 is coupled thermally, and in this particular example directly, to the flowing medium, i.e. liquid or gas.

Ferromagnetic materials are strongly attracted to a magnetic field gradient. Magnetic materials which undergo a second-order phase transition from a high-temperature paramagnetic state to a low-temperature ferromagnetic state consequently have a marked difference in their interaction with a magnet.

At high temperatures they are weakly attracted to the magnet while at low temperatures they are strongly attracted to the magnet. The valve of FIG. 2, relies on this principle. At low temperatures the component 6 is held in place by the magnet 4 (placed either outside or inside the flowing medium) thus allowing fluid to pass. As the temperature of the second part 6 increases due to an increase in ambient temperature or an increase in the temperature of the flowing fluid, the material becomes paramagnetic and detaches from the magnet 4, blocking the flow of fluid. When the temperature is lowered, the material is re-attracted to the magnet 4, and the flow opens again. Alternatively, the flow may be blocked when the material is attached to the magnet and open when the material is not. A double arrangement may be constructed where the flow is blocked when the temperature of the flowing fluid is below a certain level, and also blocked when the temperature of the fluid is above a different certain level, but open when the fluid temperature is in between the two levels.

By varying the composition of regions of the part 6, the Curie temperature of the regions of the part 6 can be made to be different. In other words, the Curie temperature of the second part as a whole is not uniform. Therefore, by moving the relative configuration of the magnet 4 and the second part 6, the region of the second part 6 that can engage with the magnet 4 changes, and so the temperature dependence of the valve 2 or the temperature at which it will switch also changes.

As explained above, the material used to form the second part 6 of the valve 2 may be ceramic. This provides the advantage that it is corrosion resistant and therefore the valve is stable over time. Furthermore, the valve can be easily manufactured using ceramic manufacturing techniques. Examples of a method for manufacturing the second part 6, with a graded Curie temperature, are described in our co-pending International patent application number PCT/EP2005/013654.

Preferably the first 4 and second 6 parts of the valve may be biased in either an open or closed position. This will serve to determine the threshold for the level of attraction for the valve to open or close. Some suitable means such as a spring may be used to bias the first and second parts together or apart. In addition the mass and magnetic strength of both the magnet and the ferromagnetic component must be balanced according to the force from the flow of fluid.

In use, the ferromagnetic material within the temperature adjustable valve is graded, i.e. has a Curie temperature varying from low to high. To set a working temperature of the valve 2, the first and second part of the valve 2 are moved relative to each other, such that the region of the second part 6 having the required Curie temperature is adjacent to the magnet 4. This will mean that the switch temperature of the valve 2 corresponds substantially to the Curie temperature of the region of the second part 6 that is in engageable proximity to the magnet 4.

In the examples shown in FIGS. 1A and 1B, the Curie temperature T_{c1} of the first region 10₁ of the second part 6 is T₀. Therefore, if the temperature of the fluid flowing within the conduit is below T₀, the assembly 6 will remain attracted to the permanent magnet 4 and therefore the conduit will be open. When the temperature of the fluid within conduit 8 rises, as shown in FIG. 1B where the temperature is T₁, the region 10₁ of the second part 6, becomes paramagnetic and therefore the second part 6 falls or is forced by a biasing means to block the flow of fluid within the conduit 8.

In FIG. 2A, the relative position of the second part 6 with respect to the magnet 4 has changed such that now, a different region 10₄ is in engageable proximity to the magnet 4. The Curie temperature T_{c4} of the region 10₄ is T₁. Therefore, for temperatures of fluid within conduit 8 less than T₁, the valve will remain open. As shown in FIG. 2B, when the temperature of the fluid reaches T₂, in which T₂ is greater than T₁, the second part 6 becomes paramagnetic and therefore falls or is forced by a biasing means to block the flow of fluid within the conduit 8.

It is important that there is thermal contact, either direct or indirect, between the fluid flowing within the conduit 8 and the part of the valve 2 that is ferromagnetic.

The second part 6 of the valve 2 may be made of a ceramic material such as La_{1-x-y}CaₓSr_{y}MnO_{3-d} or an intermetallic compound such as LaFeₓSi_{y} or alloys of Gd with e.g. Tb, Ge or Si. This provides the advantage that the temperature range of sensitivity of the valve assembly may be within the range of every day usage. Typically, Curie temperatures between −200° C. and 100° C. may be achieved using materials such as those mentioned above although any suitable materials and corresponding ranges may be used.

FIG. 3 shows a schematic representation of a magnetic valve 2. Like the example shown in and described with reference to FIGS. 1 and 2, the valve has first and second parts 4 and 6, the second part 6 being subdivided into regions 10₁, 10₂ . . . . In this example the second part 6 is in the form of a rotary dial which can be rotated such that the desired region is in engageable proximity to the magnet 4 arranged outside the conduit 8. Some membrane may be required to provide a reconfigurable boundary between the recess 12 in which the second part 6 is received when the valve is open. The second part is mounted in such a way that a user can easily rotate it such that a desired region with a required Curie temperature is in engageable proximity to the magnet 4.

The valve described above has many possible applications. In one embodiment, the moving part of the valve may be connected to an electric circuit such that a switch could be opened or closed in dependence on the movement of the valve. The valve could be used as a trigger for an indicator to provide information as to the temperature that an associated cargo has been exposed to. An embodiment such as that disclosed shown in and described in detail below with reference to FIGS. 5A and 5B would be particularly suitable for such an application.

In one embodiment, the valve is used within an irrigation system to control the flow of water for watering crops. When the ambient temperature reaches a desired high or low threshold, the valve can be configured to switch so as either to open or close the flow of water to the irrigation system. It will be appreciated that there are numerous possible applications of the valve.

FIG. 4 shows a schematic representation of part of a crop irrigation system. The system includes a sprinkler 16 connected to a conduit 8. A magnetic valve 2 such as valve shown in any of FIGS. 1 to 3 is provided which provides automatic temperature dependent control of the operation of the irrigation system. In this example, the second part 6 is preferably mounted outside the conduit and the magnet 4 is mounted within the conduit such that the ambient temperature can be used easily to control automatically when the irrigation system is switched on or off. If it were the other way round, i.e. the second part within the conduit, then it would be the temperature of the water flowing within the conduit which would control the operation of the valve. Either configuration may be used.

It is particularly advantageous that the valve is entirely passive. Therefore, no operator interaction is required to switch the valve. Indeed, the valve can operate entirely independently of operator intervention, solely dependent on the varying temperature of its environment.

FIGS. 5A and 5B show an example of an assembly which functions as an indicator or a trigger. The assembly comprises a first part 4 comprising a magnet 4 and a second part 6 comprising a ferromagnetic material. The magnet 4 is arranged between two pieces 6 of active ferromagnetic material. As the temperature increases the ferromagnet gradually becomes paramagnetic further down and the magnet thus moves down to where the material is still ferromagnetic either due to gravity or to a biasing force. If the temperature decreases again the magnet will not move back up—thus creating a maximum temperature indicator.

In FIG. 5A, the temperature is relatively low such that the second part is ferromagnetic relatively high up (in dependence on its composition). As the temperature increases the region of the second part 6 that is ferromagnetic effectively moves down (with respect to the configuration of the assembly shown in the Figure), causing corresponding downward movement of the magnet 4 (FIG. 5B). In one example, the magnet could be connected to a component of a switch (not shown) such that when the temperature reaches a certain value and the magnet 4 a corresponding position, the switch is activated. Thus, the assembly functions as a trigger for the switch.

Embodiments of the present invention have been described with particular reference to the examples illustrated. However, it will be appreciated that variations and modifications may be made to the examples described within the scope of the present invention.

1. A magnetic assembly, the assembly comprising:
a magnet; and
a ferromagnetic component having at least two regions of different Curie temperature, the magnet and the ferromagnetic component being movable with respect to each other in dependence on the temperature of the ferromagnetic component.

2. An assembly according to claim 1, in which the assembly is a valve wherein the ferromagnetic component and the magnet are movable with respect to each other to open and close the valve, at least one of the magnet and the ferromagnetic component being configurable such that the region of the ferromagnetic component that can engage with the magnet can be changed.

3. An assembly according to claim 2, arrangeable in use such that the ferromagnetic component is in thermal contact with the environment.

4. An assembly according to claim 2 or 3, in which in use the valve is arrangeable to control the flow of a fluid within a conduit, the ferromagnetic component being arranged in use to be in thermal contact with a said fluid flowing within the conduit.

5. An assembly according to any of claims 2 to 4, wherein the ferromagnetic component comprises an elongate structure having plural sections, each with a different Curie temperature.

6. An assembly according to any of claims 2 to 4, wherein the ferromagnetic component comprises a rotatable unit such that as it is rotated, the region in engageable proximity to the magnet changes.

7. An assembly according to any of claims 2 to 6, wherein the ferromagnetic component is made of a ceramic material, an intermetallic compound or an alloy.

8. An assembly according to any of claims 2 to 7, in which the magnet is for configuration on the outside of a fluid carrying conduit, and the ferromagnetic component is for arrangement within the conduit.

9. An assembly according to any of claims 1 to 8, wherein the magnet includes one or more of a permanent magnet or an electromagnet, an arrangement of permanent magnets or electromagnets, or a combination of permanent magnets and electromagnets.

10. A fluid-flow assembly, comprising:
a conduit for a flowing fluid; and,
a magnetic assembly according to any of claims 1 to 9, the magnetic assembly being arranged to provide automatic control of the flow of the fluid through the conduit.

11. A magnetic assembly according to any of claims 1 to 9, arranged such that when the magnetic assembly switches state from open to closed or closed to open an external process is triggered.

12. An indicator comprising:
a magnet; and
a ferromagnetic material component having at least two regions of different Curie temperature, the magnet and the ferromagnetic component being movable with respect to each other to indicate the state of the system.
